(19) United States
(12) Patent Application Publication
(10) Pub. No.: US 2018/0293561 A1
(43) Pub. Date: Oct. 11, 2018

(54) Method And Hand Held Electronic Device For Executing Cashless And Creditless Financial Transactions

(71) Applicants: Peter Muscat, Naxxar (MT); John George Dinkel, Irvine, CA (US)

(72) Inventors: Peter Muscat, Naxxar (MT); John George Dinkel, Irvine, CA (US)

(21) Appl. No.: 15/947,199

(22) Filed: Apr. 6, 2018

Related U.S. Application Data
(60) Provisional application No. 62/482,379, filed on Apr. 6, 2017.

(51) Int. Cl. G06Q 20/10; G06Q 20/02; G06Q 20/32; G06Q 20/40

(52) U.S. Cl. CPC G06Q 20/102; G06Q 20/105; G06Q 20/40145; G06Q 20/3223; G06Q 20/3224; G06Q 20/027

(57) ABSTRACT

A self-contained hand held mobile payment electronic device and method eliminates any use of cash or credit in making a payment from one party to another party who are both members of an association of parties, each party possessing one of the devices to execute a financial transactions between those parties. The devices all are capable of storing a credit balance deposited therein from a financial institution or other source of funds owned by the parties and transferring a payment from one party to another party of the association when the respective devices are positioned adjacent each other. A biometric sensor on each device enables transactions to be executed only when the paying party holds a finger or thumb on the biometric sensor which also indentifies the party.

### CROSS REFERENCE TO RELATED APPLICATIONS

This application claims the benefit of U.S. provisional patent application No. 62/482,379 filed on Apr. 6, 2017.

### BACKGROUND OF THE INVENTION

This invention concerns the making of a financial transaction between two or more parties, such as in making a payment for purchase of an item or for the rendering of a service for one party by another party.

The adoption of a medium of exchange, i.e., money such as coins or paper bills, greatly facilitated the conduct of commercial activity.

The use of credit transactions based on a promise to pay money in the future as by promissory notes, negotiable instruments, etc. further enhanced commercial activity reaching the levels achieved in modern times.

The use of cash money in the form of coins and paper currency, while very convenient for making purchases, has the drawback that governments incur substantial costs in maintaining a currency supply.

Another disadvantage of cash is that illegal or fraudulent activity is difficult to detect since no record of a transaction is created when cash is exchanged.

Furthermore, a desirable ability to undo a transaction because of later discovered fraud or mistakes is difficult or impractical.

Cash can also be stolen with often no way to identify the stolen cash after the fact.

Accordingly, there has developed an awareness in countries around the world of the desirability of creating a system of cashless payment transactions.

While credit transactions do not have many of the disadvantages of cash, many people do not have the ability to obtain any credit, particularly in less developed countries. Younger person also may have not yet demonstrated creditworthiness.

Another disadvantage of both cash and credit transactions is created by the use of ATMs, which have been developed to facilitate processing both cash and check transactions between banks and their customers. ATMs, while very convenient, are complex and therefore expensive to construct, operate, and maintain largely because of the need to deal with cash as well as negotiable instruments such as checks. The use of ATMs to obtain cash has created a risk of theft and the cost of repairing damage to the ATM by thieves seeking to steal the cash. Further, the perceived vulnerability of customers to possibly being robbed and injured while using an ATM is quite real given the location of most ATMs.

Credit transactions have the further substantial disadvantage of being relatively expensive, burdening the parties to a transaction and thus being a relatively inefficient way of making a payment.

It is an object of the present invention to provide a method of executing financial transactions between parties which does not involve a physical medium of exchange, i.e., cash, or any extending of credit to a party to thereby eliminate the disadvantages of executing each type of transaction as described above.

### SUMMARY OF THE INVENTION

The above recited object of the invention and other objects which will be understood by those skilled in the art are achieved by a process and devices for executing financial transactions involving individual use of devices which are each self-contained, and hand held, which can execute transactions comprising cashless and creditless mobile payments possessed by each member of an association or “club”. The financial transactions can only be made between those parties using only the self-contained mobile payment devices according to the invention.

The devices each include a battery and a programmed microprocessor and preferably also having a non volatile memory, with a screen display and a numeric keyboard as well as a send button and an indicator button.

These devices are each capable of electronically storing in a memory a digitally represented balance of funds (with a limited maximum) which was created by transfers made to the device from a financial institution or other source of funds which have accounts for each party in the association who is provided with a device.

Operation of each device must be enabled by a user contact with a biometric sensor located on each device, preferably a finger print sensor. A transfer is enabled by a user placing a finger or thumb of the user on the sensor, preferably located adjacent the keyboard to allow access to the keyboard while viewing the screen display.

Each device also includes one or more electrical contacts such as an exposed conductor or alternatively one or more magnetic contacts which can electronically couple any two of the devices which are brought into contact or close proximity with each other.

This electronic coupling enables one party to carry out a transfer of a stored amount from the memory of his or her device to a device of another party without the need of the device to be connected electronically to any other apparatus when making the transaction.

The stored balance of funds is adjusted after each transaction to reflect the transfer of funds executed by the transaction.

The memory of each mobile payment device can be initially loaded or later topped up by connecting the same to a financial institution or other source of the party's funds by being inserted into the base station connected to a financial institution or to another source of funds which are owned by the party (such as an employer) by telephone wires, internet, etc.

All of the transactions which have been carried out can be recorded by the financial institution or the other source of funds, preferably using the well known “block chain” technology to also preserve the security of the data recorded. In the case of fraud or mistake, any transaction can be undone or corrected.

Furthermore, any possibly illegal activity can be detected by an analysis of the transaction data and investigated if appropriate by the authorities.

Normally, such cashless, creditless financial transactions between members of the association are enabled to be carried out at a very low cost to all of the members of the association by being equipped with such hand held self-contained electronic device.

Individuals or small businesses may have lower limits than representatives of a large business reflecting usual difference in the relative volume of transactions to be carried out.

Activation of a device of a large business or high limit individual may be designed to require entry of a pin number, also entered in the well known manner by use of the keyboard.

Thus, since each device must be activated by detection of the user's fingerprint or other bodily feature unique to each person, loss of a device does not require immediate closing of an account or taking other preventative measures since fraudulent use is not possible due to the need for biometric identification to carry out a transaction.

### DESCRIPTION OF THE DRAWING FIGURES

FIG. 1 is a slightly enlarged front view of a hand held self-contained mobile payment device according to the present invention with a partial outline of a credit card shown in phantom lines to depict the similar size and shape of the mobile payment device.

FIG. 2 is a block diagram representation of components of the mobile payment device shown in FIG. 1.

FIG. 3 is a diagrammatic representation of the mobile payment device shown in FIG. 1 inserted into a base station enabling communication to a gateway to a financial institution or other source of funds owned by the party provided with the device for loading or topping off the credit balance indicated in the memory of the device and to update the record of transactions involving the use of that particular device.

FIG. 4 is a view of two of the hand held mobile payment devices shown in FIG. 1 positioned end to end in contact with each other to enable financial transactions to be made between the parties possessing the respective devices.

### DETAILED DESCRIPTION

In the following detailed description, certain specific terminology will be employed for the sake of clarity and a particular embodiment described in accordance with the requirements of 35 USC 112, but it is to be understood that the same is not intended to be limiting and should not be so construed inasmuch as the invention is capable of taking many forms and variations within the scope of the appended claims.

The present invention concerns financial transactions between parties such as to make a purchase or to settle a debt between the parties such as a debt arising from one party performing a service for the other party.

Such transactions are presently most commonly carried out by the payment of cash by one party to the other, or by resort to a short term credit transaction, i.e., the use of a credit card, or by payment with a negotiable instrument such as a check, or by a promissory note as described above.

The present invention seeks to conveniently enable making of such a transaction between parties by associating a number of parties with each other in a “club” or association. The transaction is not carried out by use of cash or credit or a promissory note, or by a negotiable instrument such as a check.

The association is constituted by those who have been provided a mobile transaction device according to the invention and who have established an account with an associated financial institution or with some other source holding funds owned by the parties as shown in FIG. 1, the device 10 has a rectangular molded plastic housing 12 which is sized and shaped to be conveniently hand held, approximately the size of a credit card 22 but of a greater thickness to accommodate the battery and electronics described below contained within the housing 12.

A display screen 14 extends across the top of the housing 12. Above the display screen 14 is an array of electrical contacts 16 designed to electrically connect two devices 10 when placed adjacent to each other, preferably in end to end contact with the contacts 16 touching to each other (FIG. 4), for the purpose of executing a transaction between the parties.

Such contacts may also be magnetic in nature so as to not require actual touching of the two devices 10A, 10 but only proximate positioning with each other. The contacts can be variously configured and could be molded into the housing 12.

Preferably below the display screen 14 is a numeric key pad 18 for entry of amounts to be transferred in a particular transaction, together with a cancel or “C” button 34.

At the bottom left of the housing 12 is a triangular “send” or “pay” button 20 preferably colored to be conspicuous, such as in red. Next to the send or pay button 20 is a biometric sensor 26, which preferably detects contact of a user's unique body feature such as a fingerprint in order to allow execution of a transaction.

To the right of the sensor 26 is an indicator button 24 preferably of a contrasting color such as blue, and also preferably of a shape differing from the send button 20, such as the round shape shown. The indicator button 24 is also caused to be illuminated whenever a transaction has been successfully executed.

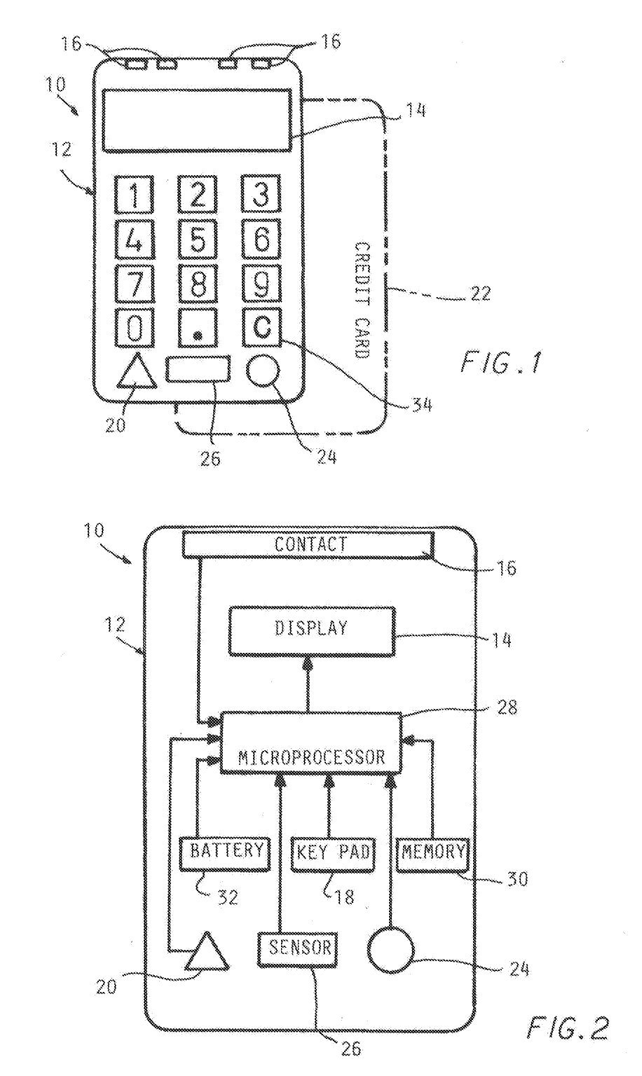

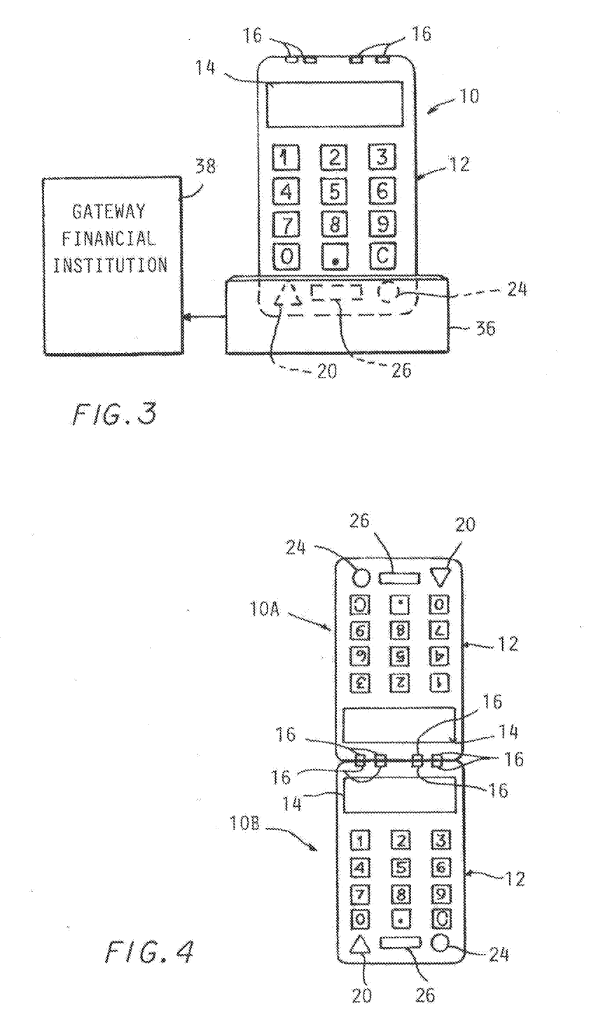

Referring to FIG. 2, a block diagram of the basic components of the mobile payment device 10 is shown, including those enclosed components contained within the housing 12 and not shown in FIG. 1.

The components of the mobile payment device 10 include conventional electronic elements which enable the various operations described above and below. These include a microprocessor 20 and write only memory 30 which are powered by a thin lithium ion battery 32. Security of the device 10 may be enhanced by using a memory 30 able to be written to but not read by the same circuit, i.e.; the hardware can read the instruction but the processor cannot.

The various operations which the device 10 can preferably be programmed to perform are as follows:

### To Check Available Balance & Transactions

Press indicator button 24 to display the current balance.

Press keypad C button 34 to cancel and go back to 0.

The screen display 14 will go blank after 5 seconds if no action is taken by the user.

### To View Transactions

Press indicator button 24 once and the credit balance is displayed.

Press indicator button 24 twice, and the last payment made will then be shown on the display 14.

Repeat pressing of the indicator button 24 will sequentially view earlier payments made.

### To Make a Payment

Press sender's send/pay button 20.

Input the amount using sender's keypad 18.

Put finger/thumb against sensor 26.

If authenticated, indicator button 24 will light up.

Bring receiver's device 10B into juxtaposition (FIG. 4).

If the transaction is successful, send or pay button 20 and the indicator button 24 will both light up on the sender's device 10A. Also a “success” message may appear on the display 14.

On the receiver's device 10B, a “success” message will also appear, and also both send button 20 and indicator button 24 will light up.

### To Pay Above Predefined Secured Limit

Press activator button 20.

Input the amount to be transferred.

Put finger or thumb against sensor.

Display 14 will show entry of a prompt for a PIN.

Enter PIN.

If authenticated, the indicator button 24 will light up

Position the sender's device 10A to have the top end be contacting the top of the receiver's device 10B.

If the transaction is successful, the send button 20 will light up. Also a success message will appear on the screen.

On the receiver's device 10B, a success message will be shown. Both send and indicator buttons 20, 24 will light up.

### To ‘Top Up’ or Load the Device

The device 10 connects to an online for a financial institution gateway platform 30 or other source of funds owned by the party possessed of a device 10 via a specialized hardware base station 38. Base station 36 is similar to a credit card charge terminal in wide use. It is not necessary for the party to procure one of the base stations 36 if there is one is available as at a business establishment nearby. Such base station 36 is much simpler and cheaper than an ATM.

Place device 10 into a recess in the base station 36.

Display 14 will notify the user that the device 10 is ready to be loaded or topped up.

Take out the device 10 and enter an amount.

Authenticate the finger print by placing the party is finger or thumb on sensor 26.

Indicator button 24 will light up.

Again establish contact of device 10 with the base station 36 which is connected to a payment gateway 38 of a financial institution or other source of funds, such as an employer via a computer/Smartphone, or directly via the internet, phone line, or Wi-Fi, etc.

The base station 36 will connect to the financial gateway 38, which in turn will connect to a pre-configured bank account with a financial institution or other source of funds owned by the party. This amount is then transferred to the device 10 to top up or load the device 10. Display 14 will indicate a successful transaction message.

Balances will be updated to reflect the transaction.

Check balance to confirm transaction.

Suitable electronics components are commercially available, such as a FHU3020-1 WBF Hybrid Fingerprint Module USB I/F (PCB) which may be used for the biometric sensor 26

This hybrid sensor is 1.2 mm thick with an effective capture area of 8 mm×8 mm and an ultra-high resolution of 1000 dpi (320×320 pixels). It can recognize refined fingerprint details such as sweat pores and can detect dry/moist, fine/rough and fake fingerprints. In addition, the hybrid sensor matching with either 6H of coating or 8H of glass can withstand more than one million abrasion resistances. These sensors have passed 15 KV ESD tests and high ambient light tests (high power halogen lamp, >1,000,000 lux). The hybrid sensor has an operating voltage of 3.3V, operating current of 30 mA, standby current of % μA and operating temperature range of −20°˜+60° C.

As an alternative, the Synaptics® VFS7500S Natural ID™ fingerprint sensor family featuring SentryPoint™ Security Suite technology. Sentry Point offers a wide-range of unique and highly secure authentication features including Quantum Matcher™ for fingerprint template authentication, and PurePrint™ anti-spoof technology. Security is also enhanced using Synaptics' SecureLink™ 256-bit AES with TLS 1.2 encryption. This single-chip solution does not require an external microcontroller for handling the cryptographic functions.

A key requirement of the device 10 is that the data recorded has to be as trustworthy as possible. To provide such requirement, mobile payment device 10 may use a form of OTP (one time programmable) memory; a special type of non-volatile memory (NVM) that permits data be written to memory only once.

Once the memory has been programmed, it retains its value upon loss of power (i.e., is non-volatile). OTP memory is used in applications where reliable and repeatable reading of data is required and various specifications are available commercially.

As to the display 14, one candidate is the G-12864P8T-VA is a 1.20″ 128×64 Monochrome LCD Display which has a module size of 34.0×24.22×1.8 mm

It has an active area of 25.58×15.98. The G-12864P8T-VA 128×64 display uses Super Twisted Nematic or Film Compensated Super Twisted Nematic glass with no backlighting and a reflective, transflective, transmissive display.

An ultrathin rechargeable lithium polymer battery 32 is available through

### PowerStream Technology

### 1163 South 1680 West

### Orem Utah 84058

### USA

### Cage Code: 07TM6

and

### Lund Instrument Engineering, Inc.

For the microprocessor 28, various options are available from Atmel, FIPS 140-2 Certified Trusted Platform Module (TPM) provides strong hardware-based public key (RSA) security for both personal computers and embedded processors on a single chip. It is a complete turnkey system that integrates industry-leading Atmel AVR® microcontroller architecture, Atmel EEPROM technology, and Atmel security technology.

The housing 12 should be completely sealed and waterproof, preferably made from a molded plastic, and tamper and scratch resistant to be able to handled frequently.

Those skilled in the art will appreciate additional security measures over the inherent security of the design should be taken such as block chain technology to safeguard the information generated by transactions executed by use of the mobile payment device 10 as described herein.

1. A battery powered self-contained hand held device for executing a financial transaction between any two parties belonging to an association, each party in said association provided with one of said devices, each device having a numeric keypad operatively connected to a microprocessor and memory which memory has been previously loaded with a digital representation of a sum of money, each device able to designate a sum of money to be transferred to another device, upon activation of a send button of said device; said device further having a display on which is displayed a numeric value corresponding to said digital representation to be sent to the other party by operation of said send button;
each of said devices having one or more contacts for electronically connecting one of said devices to any other of said devices when said one of said devices is placed next to said other device, and, upon activation of said send button of said one device, said digital representation of said sum is sent from said device to another device via said one or more contacts and added to any previously loaded digital representation in a memory of said other device and subtracted from said sum in said memory of said sending device to thereby complete said transaction.

2. The device according to claim 1 wherein said one or more contacts comprise exposed conductors located on one side of each of said devices able to be contacted by said contacts of any of said other devices by bringing said devices together to cause said contacts to be touching each other.

3. The device according to claim 1 wherein said one or more contacts comprise magnetic contacts which establish an electrical connection with any other device by said devices being placed closely spaced from each other but without touching each other.

4. The device according to claim 1 wherein said device is of a size and shape approximating a conventional credit card.

5. The device according to claim 1 wherein said biometric sensor comprises a sensor adopted to detect positioning of a user's thumb or finger thereon to enable operation of said send button only if said thumb or finger of said user has been placed on said biometric sensor.

6. The device according to claim 1 further including a previously set limit on the amount of said digital representation of said sum of money which can be held in memory and which can be sent from said one device to said another device.

7. The device according to claim 1 wherein each device is sized and configured to be held in one hand of a user.

8. A method of conducting cashless and creditless financial transactions comprising:
establishing an association of parties who are to be enabled to carry out said cashless and creditless financial transactions between parties of said association;
providing each of said parties with a personalized battery powered, self-contained hand held electronic device enabling execution of said financial transactions, each device including a numeric keyboard able to be operated to set a desired numeric amount to be transferred from one party to another party in a financial transaction between parties in said association;
said numeric amount transmitted to a display on each device associated with said key board of each device to provide a numeric display of said numeric amount;
each device also having a digital memory in which a total numeric amount is stored therein said total amounts in each device initially transferred from a source of funds owned by each party provided with a respective device, said memory enabled to be preloaded therein by a temporary connection to a base station also connected to a financial institution or other source of funds owned by said parties with said amount stored in said memory of each device;
setting up a separate personal account with said financial institution or said other source of funds with each party of said association;
any one of said devices provided able to be temporarily electronically connected to any other device provided by one of the other parties by being positioned adjacent to each other;
connecting said keyboard of each device electronically to said memory and display to show an amount set by operation of said keyboard to be transferred to a memory of said another device;
also providing each device with a send button which when activated sends said set amount to said memory of said any other device;
providing an identifier on each device which detects the presence of the party next to said device when said party executing a transaction therewith;
prevent activation of said send button if the presence of said party next to said device is not detected by said identifier; and
causing said respective memories of said one and send other devices to be adjusted to reflect the result of said transfer whereby said transaction is thereby completed.

9. The method according to claim 8 wherein said party identifier comprises a fingerprint sensor on which a user must place a finger or thumb thereon to be identified by said device.

10. The method according to claim 9 wherein previous executed transactions are sent from said device to said base station and to said financial institution or other source of funds when each of said device is connected to said financial institution or other source of funds.
